(19) United States
(12) Patent Application Publication
(10) Pub. No.: US 2020/0325859 A1
(43) Pub. Date: Oct. 15, 2020

(54) DEVICE AND METHOD FOR PURIFYING EXHAUST GAS AND CONTROL METHOD THEREOF

(71) Applicants: Hyundai Motor Company, Seoul (KR); Kia Motors Corporation, Seoul (KR)

(72) Inventors: Won Bin Kim, Seongnam (KR); Mu Young Choi, Seongnam (KR)

(21) Appl. No.: 16/539,101

(22) Filed: Aug. 13, 2019

(30) Foreign Application Priority Data
Apr. 9, 2019 (KR) 10-2019-0041165

(51) Int. Cl. F02M 26/35; F02M 26/15; F02M 26/23; F02D 41/00; F02D 41/02

(52) U.S. Cl. CPC F02M 26/35; F02M 26/15; F02D 41/025; F02D 41/0077; F02M 26/23

(57) ABSTRACT

A device and a method for purifying exhaust gas are provided to reduce hydrocarbon emissions during a cold start by using an exhaust gas recirculation (EGR) system. The device is configured to purify hydrocarbon (HC) contained in the exhaust gas in an exhaust line of an engine having an exhaust gas recirculation (EGR) system. The device includes a warm-up catalytic converter (WCC) disposed on the exhaust line connected to the engine and a recirculation line disposed upstream or downstream of the WCC on the exhaust line and through which the exhaust gas is recirculated to the engine. An HC adsorption/desorption device is disposed on the recirculation line and configured to adsorb and desorb the HC contained in the exhaust gas through an HC adsorption catalyst

### CROSS REFERENCE TO RELATED APPLICATION

The present application claims priority to Korean Patent Application No. 10-2019-0041165, filed Apr. 9, 2019, the entire contents of which is incorporated herein for all purposes by this reference.

### BACKGROUND

### Field of the Invention

The present invention relates generally to a device and a method for purifying exhaust gas and a control method thereof, and more particularly, to a device and a method for purifying exhaust gas and a control method thereof, wherein hydrocarbon emissions during a cold start are reduced using an exhaust gas recirculation (EGR) system.

### Description of the Related Art

In general, a vehicle using an internal combustion engine burns fuels in the engine to obtain power required for driving the vehicle. During such burning of fuels in the engine, combustion gas is inevitably generated. This combustion gas is discharged into the atmosphere through an exhaust line connected to the engine. Therefore, the combustion gas generated in the burning process in the engine is referred to as exhaust gas. Exhaust gas, which is combustion gas generated as a result of burning of fuels, contains harmful substances such as hydrocarbon (HC), carbon monoxide (CO), and nitrogen oxides (NOx). With the growing international interest in the environment and the issue of air pollution in recent years, various exhaust gas purification devices for reducing such harmful substances contained in exhaust gas emitted from vehicles have been used in vehicles.

An exhaust gas purification device is generally configured to purify exhaust gas using a filter or a catalyst. For example, an exhaust gas purification device using a catalyst oxidizes HC and CO, turning the same into carbon dioxide and water, while reducing NOx into harmless nitrogen and oxygen. Such an exhaust gas purification device using a catalyst may be classified into a warm-up catalytic converter (WCC) and an under-floor catalytic converter (UCC) based on mounting position. The WCC is mounted downstream of an exhaust manifold in proximate to an engine, and the UCC is mounted under a vehicle floor at an intermediate position of a muffler pipe with a predetermined distance from the exhaust manifold.

The WCC and the UCC may use a three-way catalyst (TWC). The TWC almost completely purifies HC, CO, and NOx when the TWC reaches a light-off temperature (LOT). However, the TWC is problematic in that purification performance may be reduced during a period before the TWC reaches the LOT, such as during a cold start, resulting in a substantial amount of harmful substances being directly discharged into atmosphere.

Therefore, in recent years, a technique for preventing HC from being discharged into atmosphere even during a cold start using an HC adsorption catalyst has been developed. The HC adsorption catalyst adsorbs HC during a period before the TWC of the WCC and the TWC of the UCC reach the LOT, such as during a cold start, and desorbs the adsorbed HC during a period after the TWC of the WCC and the TWC of the UCC reach the LOT. The HC adsorption catalyst is required to have ability of adsorbing HC at a low temperature and desorbing the adsorbed HC at a high temperature. Accordingly, zeolite known to have the above-mentioned ability is used as the HC adsorption catalyst.

The HC adsorption catalyst may find in application in a gasoline vehicle in which an excessive amount of HC is discharged during a cold start. Therefore, HC in exhaust gas is adsorbed to the zeolite at a low temperature state such as during a cold start. The adsorbed HC is desorbed from the zeolite at a high temperature and flows together with the exhaust gas. At this time, the TWC of the WCC and the TWC of the UCC reach the LOT, thus purifying the HC. Therefore, hydrocarbon reduction effect may be expected from such a purifying mechanism.

Meanwhile, the above-described mechanism for purifying HC is based upon a premise that a temperature at which the HC is desorbed from the zeolite is equal to or greater than a temperature at which the TWC of the WCC and the TWC of the UCC are activated. However, the temperature at which the HC is desorbed from the zeolite is less than the LOT of the TWC of the WCC and the LOT of the TWC of the UCC. This may cause a problem in that the TWC of the WCC and the TWC of the UCC have difficulty completely purifying the HC desorbed from the zeolite. Therefore, there is a demand for a method that enables the TWC to reach the LOT quickly, or a method that enables HC to be additionally adsorbed until the TWC reaches the LOT.

Furthermore, FIG. 1 is a view showing a configuration of an exhaust gas purification device to which an exhaust gas recirculation (EGR) system is applied according the related art. The EGR system is a system for recirculating a portion of exhaust gas emitted from an engine to an intake line of the engine. The EGR system is provided upstream or downstream of a WCC 20 on an exhaust line connected to an engine 10 and recirculates exhaust gas to the engine 10. The EGR system includes a recirculation line 40 that branches from the exhaust line and through which the exhaust gas is recirculated to the engine 10. The recirculation line 40 includes thereon an EGR cooler 41 and an EGR valve 42. Furthermore, a UCC 30 is disposed downstream of the WCC 20. The applicant herein has devised the present invention based on an idea that HC may be additionally adsorbed until the TWC reaches the LOT using the EGR system.

The foregoing is intended merely to aid in the understanding of the background of the present invention, and is not intended to mean that the present invention falls within the purview of the related art that is already known to those skilled in the art.

### SUMMARY

Accordingly, the present invention provides a device and a method for purifying exhaust gas and a control method thereof, wherein hydrocarbon (HC) is additionally adsorbed until a three-way catalyst (TWC) reaches a light-off temperature (LOT) using an exhaust gas recirculation (EGR) system, thus reducing excessive emissions of the HC during a cold start.

In order to achieve the above objective, according to one aspect of the present invention, t a device for purifying exhaust gas may be configured to purify hydrocarbon (HC) contained in the exhaust gas in an exhaust line of an engine that is provided with an exhaust gas recirculation (EGR) system and may include: a warm-up catalytic converter (WCC) disposed on the exhaust line connected to the engine; a recirculation line disposed upstream or downstream of the WCC on the exhaust line and through which the exhaust gas is recirculated to the engine; and an HC adsorption/desorption device disposed on the recirculation line and configured to adsorb and desorb the HC contained in the exhaust gas through an HC adsorption catalyst.

The HC adsorption catalyst disposed in the HC adsorption/desorption device may be zeolite. The recirculation line may include an EGR cooler and EGR valve sequentially arranged on the recirculation line along a flow direction of the exhaust gas, and the HC adsorption/desorption device may be disposed upstream of the EGR cooler.

The device may further include a controller configured to adjust the opening and closing operations of the EGR valve in response to an adsorption amount of HC that is adsorbed to the HC adsorption/desorption device and in response to whether a three-way catalyst (TWC) of the WCC reaches a light-off temperature (LOT). In particular, the controller may be configured to open the EGR valve during a cold start, thus allowing the exhaust gas to pass through the HC adsorption/desorption device such that the HC contained in the exhaust gas is adsorbed to the HC adsorption/desorption means. When an adsorption amount of HC is increased with the EGR valve opened and thus the adsorption amount of HC becomes greater than a predetermined adsorption capacity of the HC adsorption/desorption device, the controller may be configured to close the EGR valve, thus stopping adsorption of the HC. When the TWC of the WCC reaches the LOT with the EGR valve closed, the controller may be configured to open the EGR valve, thus allowing the HC adsorbed to the HC adsorption/desorption device to be desorbed due to a temperature of the exhaust gas.

According to another aspect of the present invention, a method of purifying exhaust gas, the method being configured to purify hydrocarbon (HC) contained in the exhaust gas in an exhaust line of an engine having a recirculation line through which the exhaust gas is recirculated to the engine and a warm-up catalytic converter (WCC), and may include: adsorbing the HC contained in the exhaust gas by the recirculation line before a three-way catalyst (TWC) of the WCC reaches a light-off temperature (LOT); and after the TWC of the WCC reaches the LOT, allowing the HC adsorbed by the recirculation line to be desorbed and then to flow to the WCC for purification.

According to still another aspect of the present invention, a control method of a device for purifying exhaust gas, the control method being configured to operate the device for purifying hydrocarbon (HC) contained in the exhaust gas in an exhaust line of an engine having a recirculation line having an HC adsorption/desorption device and through which the exhaust gas is recirculated to the engine and a warm-up catalytic converter (WCC), and may include: in response to detecting that the engine is turned on in a cold state, allowing the HC contained in the exhaust gas to be adsorbed to the HC adsorption/desorption device while recirculating the exhaust gas to the recirculation line; firstly determining whether flow of the exhaust gas to the recirculation line is allowed by comparing a predetermined adsorption capacity of the HC adsorption/desorption device with an adsorption amount of HC adsorbed to the HC adsorption/desorption device; as a result of comparing the predetermined adsorption capacity of the HC adsorption/desorption device with the adsorption amount of HC adsorbed to the HC adsorption/desorption device, when the adsorption amount is greater than the adsorption capacity, blocking flow of the exhaust gas to the recirculation line; secondly determining whether flow of the exhaust gas to the recirculation line is allowed by detecting whether a three-way catalyst (TWC) of the WCC reaches a light-off temperature (LOT); and when the TWC of the WCC reaches the LOT, allowing the HC adsorbed to the HC adsorption/desorption device to be desorbed due to a temperature of the exhaust gas by allowing flow of the exhaust gas to the recirculation line.

An HC adsorption catalyst disposed in the HC adsorption/desorption device may be zeolite, and in response to detecting that the engine is turned on, an EGR valve may be opened to allow the exhaust gas to pass through the HC adsorption/desorption device such that the HC contained in the exhaust gas is adsorbed to the HC adsorption/desorption device. In the blocking flow of the exhaust gas to the recirculation line, the opened EGR valve may be closed to block the exhaust gas from flowing to the recirculation line, thus stopping adsorption of the HC contained in the exhaust gas to the HC adsorption/desorption device. In the allowing the HC adsorbed to the HC adsorption/desorption device to be desorbed, the closed EGR valve may be opened to allow flow of the exhaust gas to the recirculation line, whereby the HC adsorbed to the HC adsorption/desorption device may be desorbed due to the temperature of the exhaust gas and then flow into the engine, and then the HC that is discharged from the engine may flow to the WCC for purification.

In the first determination of whether flow of the exhaust gas to the recirculation line is allowed, the predetermined adsorption capacity of the HC adsorption/desorption device may be compared with the adsorption amount of HC adsorbed to the HC adsorption/desorption device, whereby when the adsorption amount is equal to or less than the adsorption capacity, the EGR valve may be maintained in an open state, and when the adsorption amount is greater than the adsorption capacity, the EGR valve may be closed. In the second determination of whether flow of the exhaust gas to the recirculation line is allowed, whether the TWC of the WCC reaches the LOT may be detected, whereby before the TWC of the WCC reaches the LOT, the EGR valve may be maintained in a closed state, and after the TWC of the WCC reaches the LOT, the EGR valve may be opened.

According to the exemplary embodiments of the present invention, through provision of the HC adsorption/desorption device that is provided at the EGR system to adsorb and desorb the HC, the HC may be adsorbed during a cold start to prevent discharge into the atmosphere. This makes it possible to reduce excessive emissions of the HC during a cold start. Furthermore, the adsorbed HC may be desorbed from the HC adsorption/desorption device from time when the TWC of the WCC reaches the LOT, and then the desorbed HC may be allowed to flow to the WCC and purified by the TWC.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a view showing a configuration of an exhaust gas purification device to which an exhaust gas recirculation (EGR) system is applied according the related art;

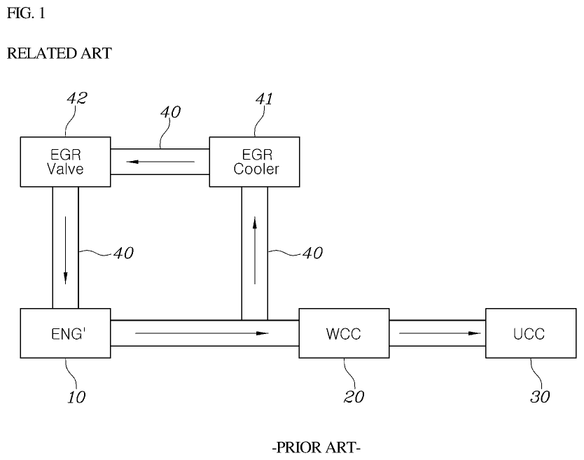

FIG. 2 is a view showing a configuration of a device for purifying exhaust gas according to an exemplary embodiment of the present invention; and

FIG. 3 is a flowchart showing a control method of the device for purifying exhaust gas according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, ^{an} and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinbelow, exemplary embodiments of the present invention will be described in detail with reference to the accompanying drawings. However, the exemplary embodiments of the present invention are presented to make complete disclosure of the present invention and help those who are ordinarily skilled in the art best understand the invention. Various changes to the following embodiments are possible and the scope of the present invention is not limited to the following embodiments. Throughout the drawings, the same reference numerals will refer to the same or like parts.

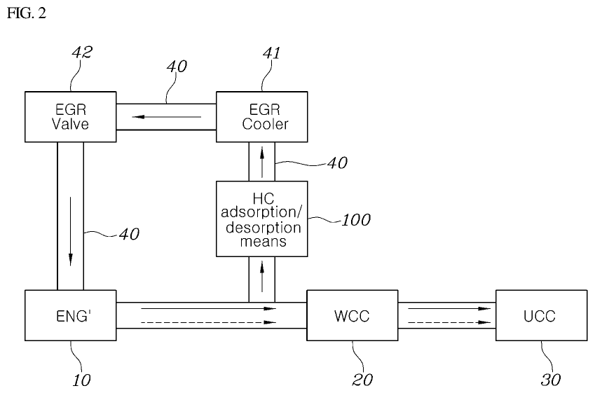

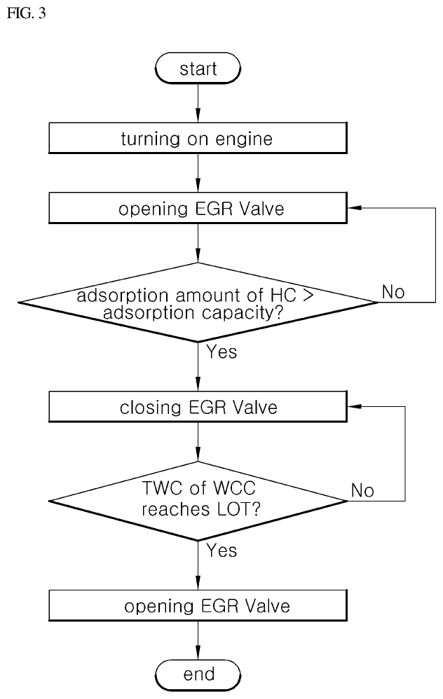

FIG. 2 is a view showing a configuration of a device for purifying exhaust gas according to an exemplary embodiment of the present invention, and FIG. 3 is a flowchart showing a control method of the device for purifying exhaust gas according to an exemplary embodiment of the present invention. As shown in the drawings, a device for purifying exhaust gas according to an exemplary embodiment of the present invention is a device configured to purify hydrocarbon (HC) contained in the exhaust gas in an exhaust line of an engine 10 having an exhaust gas recirculation (EGR) system.

Thus, the device for purifying exhaust gas according to the exemplary embodiment of the present invention may include: a warm-up catalytic converter (WCC) 20 disposed on the exhaust line connected to the engine 10; a recirculation line 40 disposed upstream or downstream of the WCC 20 on the exhaust line and through which exhaust gas may be recirculated to the engine 10; and an HC adsorption/desorption device 100 disposed on the recirculation line 40 and configured to adsorb and desorb the HC contained in the exhaust gas through an HC adsorption catalyst

In particular, the device for purifying exhaust gas according to the exemplary embodiment may include the WCC 20 disposed downstream of the engine 10 on the exhaust line connected to the engine 10, and an under-floor catalytic converter (UCC) 30 disposed downstream of the WCC 20 with a predetermined distance from the engine 10. Herein, a three-way catalyst (TWC) for purifying HC may be applied to the WCC 20 and to the UCC 30. Furthermore, the recirculation line 40 through which the exhaust gas is recirculated to the engine 10 may be connected to an upstream side of the WCC 20.

The recirculation line 40 may include an EGR cooler 41 and an EGR valve 42 that are sequentially arranged on the recirculation line along a flow direction of exhaust gas. Therefore, it may be possible to control whether flow of exhaust gas is recirculated to the recirculation line 40 through opening and closing operations of the EGR valve 42. Herein, such above-described configurations of the WCC 20, the UCC 30, the recirculation line 40, the EGR cooler 41, and the EGR valve 42 may be variously modified and implemented to perform essential functions thereof at a level of technology commonly used in the art.

Meanwhile, the HC adsorption/desorption device 100 configured to adsorb and desorb the HC contained in the exhaust gas may be disposed on the recirculation line 40. Herein, the HC adsorption/desorption device 100 may be provided upstream of the EGR cooler 41. Accordingly, the HC contained in the exhaust gas may be adsorbed to the HC adsorption/desorption device 100 during a cold start before the TWC of the WCC 20 reaches a light-off temperature (LOT). The HC adsorbed to the HC adsorption/desorption device 100 may be desorbed after the TWC of the WCC 20 reaches the LOT. Accordingly, the HC adsorption/desorption device 100 may include the HC adsorption catalyst having ability of adsorbing HC at a low temperature and desorbing the adsorbed HC at a high temperature. It is preferable that zeolite known to have the above-mentioned ability be used as the HC adsorption catalyst.

The zeolite used as the HC adsorption catalyst adsorbs HC at a low temperature to prevent the HC contained in the exhaust gas from being directly discharged into atmosphere. However, use of the zeolite is problematic in that a temperature at which the adsorbed HC is desorbed from the zeolite is less than a temperature at which the TWC of the WCC 20 reaches the LOT.

Therefore, to prevent adsorbed HC from being desorbed from the HC adsorption/desorption device 100 before the TWC of the WCC 20 reaches the LOT, the present invention may adjust opening and closing operations of the EGR valve 42 such that flow of the exhaust gas to the recirculation line 40 provided with the HC adsorption/desorption device 100 is suppressed for a predetermined period of time. In particular, the present invention may further include a controller (not shown) configured to open and close the EGR valve 42 in response to an adsorption amount of HC that is adsorbed to the HC adsorption/desorption device 100 and in response to whether the TWC of the WCC 20 reaches the LOT. Herein, the controller may be an electronic control unit (ECU) generally mounted within a vehicle.

The controller according to an exemplary embodiment of the present invention may be implemented through a nonvolatile memory (not shown) configured to store an algorithm configured to control operations of various components of a vehicle or data relating to software instructions that runs the algorithm, and through a processor (not shown) configured to perform operations to be described below using the data stored in the memory. Herein, the memory and the processor may be implemented as individual chips. Alternatively, the memory and the processor may be implemented as a single chip on which the memory and the processor are integrated. The processor may be implemented in the form of one or more processors.

Therefore, the controller may be configured to open the EGR valve 42 during a cold start, thus allowing exhaust gas to flow to the recirculation line 40. The exhaust gas being recirculated may pass through the HC adsorption/desorption device 100 disposed on the recirculation line 40, whereby the HC contained in the exhaust gas may be adsorbed to the HC adsorption catalyst.

When the EGR valve 42 is maintained in an open state in such a manner, the exhaust gas may be continuously recirculated to the recirculation line 40, and thus the adsorption amount of HC adsorbed to the HC adsorption/desorption device 100 may be gradually increased. Accordingly, when the adsorption amount of HC becomes greater than a predetermined adsorption capacity of the hydrocarbon adsorption/desorption device 100, the controller may be configured to close the EGR valve 42, thus blocking the exhaust gas from flowing to the recirculation line 40. This causes adsorption of the HC to the HC adsorption/desorption device 100 to be stopped. Since the exhaust gas is blocked from flowing to the recirculation line 40, desorption of the adsorbed HC from the HC adsorption catalyst due to temperature increase of the HC adsorption/desorption device 100 may be suppressed.

When the TWC of the WCC 20 reaches the LOT with the EGR valve 42 closed, the controller may be configured to open the EGR valve 42, thus allowing the exhaust gas to flow again to the recirculation line 40. Then, the temperature of the HC adsorption/desorption device 100 increases due to the temperature of the exhaust gas, causing the HC adsorbed to the HC adsorption catalyst to be desorbed. The HC thus desorbed may flow through the recirculation line 40 and then may pass through the WCC 20, whereby the HC may be purified by the TWC.

On the other hand, a method of purifying exhaust gas may be implemented by the device for purifying exhaust gas configured as described above in a manner that the HC contained in the exhaust gas is adsorbed by the recirculation line 40 before the TWC of the WCC 20 reaches the LOT, and the HC adsorbed by the recirculation line 40 is desorbed and then flows into the engine 10 after the TWC of the WCC 20 reaches the LOT, and then the HC that is discharged from the engine 10 may flow to the WCC 20 for purification.

A control method of the device for purifying exhaust gas to implement the proposed method of purifying exhaust gas will be described in detail with reference to FIG. 3 The method described herein below may be executed by a controller mounted within the vehicle. As shown in FIG. 3, the control method of the device for purifying exhaust gas according to an exemplary embodiment of the present invention may include in response to determining that an engine 10 is turned on in a cold state, opening an EGR valve 42 to allow exhaust gas to flow to a recirculation line 40 to pass through an HC adsorption/desorption device 100, whereby HC contained in the exhaust gas may be adsorbed to an HC adsorption catalyst of the HC adsorption/desorption device 100 (adsorption step). At this time, flow of the exhaust gas follows the solid line in FIG. 2.

When the adsorption step is maintained, the exhaust gas may be continuously discharged from the engine 10, causing an adsorption amount of HC that is adsorbed to the HC adsorption/desorption device 100 to be increased. However, the HC adsorption/desorption device 100 has a limited predetermined adsorption capacity. Accordingly, whether flow of the exhaust gas to a recirculation line 40 is allowed may be determined by comparing the predetermined adsorption capacity of the HC adsorption/desorption device 100 with the adsorption amount of HC adsorbed to the HC adsorption/desorption device 100 (first determination step).

Accordingly, as a result of comparing the predetermined adsorption capacity of the HC adsorption/desorption device 100 with the adsorption amount of HC adsorbed to the HC adsorption/desorption device 100, when the adsorption amount is equal to or less than the adsorption capacity, the EGR valve 42 may be maintained in an open state to allow the exhaust gas to continuously flow to the recirculation line 40, whereby the HC contained in the exhaust gas may be adsorbed to the HC adsorption/desorption device 100.

Furthermore, when the adsorption amount of HC adsorbed to the HC adsorption/desorption device 100 is greater than the adsorption capacity of the HC adsorption/desorption device 100, the EGR valve 42 may be closed to block the exhaust gas from flowing to the recirculation line 40, whereby the temperature of the HC adsorption/desorption device 100 may be suppressed from increasing to the temperature at which the adsorbed HC is desorbed, while preventing the HC from being adsorbed further to the HC adsorption/desorption device 100 (blocking step).

As a result, a maximum amount of HC may be adsorbed to the HC adsorption/desorption device 100 during a cold start This makes it possible to minimize the amount of HC that is discharged into the atmosphere within the adsorption capacity of the HC adsorption/desorption device 100. Accordingly, in a state in which the EGR valve 42 is closed, flow of the exhaust gas follows the dotted line in FIG. 2. When the exhaust gas is continuously discharged in this state, the temperature of the exhaust gas increases.

When the temperature of a three-way catalyst (TWC) of a warm-up catalytic converter (WCC) 20 increases due to such temperature rise of the exhaust gas, whether flow of the exhaust gas to the recirculation line 40 is allowed may be determined by detecting whether the TWC of the WCC 20 reaches a light-off temperature (LOT) (second determination step). Therefore, before the TWC of the WCC 20 reaches the LOT, the EGR valve 42 may be maintained in a closed state. After the TWC of the WCC 20 reaches the LOT, the EGR valve 42 may be opened to allow the exhaust gas to flow again to the recirculation line 40 along the solid line in FIG. 2.

When the exhaust gas increased in temperature flows to the recirculation line 40 and passes through the HC adsorption/desorption device 100, the temperature of the HC adsorption catalyst of the HC adsorption/desorption device 100 increases due to the temperature of the exhaust gas, whereby the HC adsorbed to the HC adsorption catalyst may be desorbed (desorption step). The HC desorbed from the HC adsorption/desorption device 100 may flow into the engine 10. Then, the HC that is discharged from the engine 10 may be purified while passing through the WCC 20. Furthermore, the HC that remains in the WCC 20 without purification after passing through the WCC may be purified while passing through an under-floor catalytic converter 30.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A device for purifying exhaust gas, the device being configured to purify hydrocarbon (HC) contained in the exhaust gas in an exhaust line of an engine having an exhaust gas recirculation (EGR) system, and comprising:
a warm-up catalytic converter (WCC) disposed on the exhaust line connected to the engine;
a recirculation line disposed upstream or downstream of the WCC on the exhaust line and through which the exhaust gas is recirculated to the engine; and
an HC adsorption/desorption device disposed on the recirculation line and configured to adsorb and desorb the HC contained in the exhaust gas through an HC adsorption catalyst

2. The device of claim 1, wherein the HC adsorption catalyst that is provided in the HC adsorption/desorption device is zeolite.

3. The device of claim 1, wherein the recirculation line includes an EGR cooler and EGR valve that are sequentially arranged on the recirculation line along a flow direction of the exhaust gas, and the HC adsorption/desorption device is disposed upstream of the EGR cooler.

4. The device of claim 3, further comprising:
a controller configured to open and close the EGR valve in response to an adsorption amount of HC that is adsorbed to the HC adsorption/desorption device and in response to whether a three-way catalyst (TWC) of the WCC reaches a light-off temperature (LOT),
wherein the controller is configured to open the EGR valve during a cold start to allow the exhaust gas to pass through the HC adsorption/desorption device to adsorb the HC contained in the exhaust gas to the HC adsorption/desorption device, and
wherein when an adsorption amount of HC is increased with the EGR valve opened, the adsorption amount of HC becomes greater than a predetermined adsorption capacity of the HC adsorption/desorption device, the controller is configured to close the EGR valve to stop adsorption of the HC, and
wherein when the TWC of the WCC reaches the LOT with the EGR valve closed, the controller is configured to open the EGR valve to allow the HC adsorbed to the HC adsorption/desorption device to be desorbed due to a temperature of the exhaust gas.

5. A method of purifying exhaust gas, the method purifying hydrocarbon (HC) contained in the exhaust gas in an exhaust line of an engine having a recirculation line through which the exhaust gas is recirculated to the engine and a warm-up catalytic converter (WCC), and comprising:
adsorbing the HC contained in the exhaust gas by the recirculation line before a three-way catalyst (TWC) of the WCC reaches a light-off temperature (LOT); and
after the TWC of the WCC reaches the LOT, allowing the HC adsorbed by the recirculation line to be desorbed and then to flow to the WCC for purification.

6. A control method of a device for purifying exhaust gas, the control method operating the device for purifying hydrocarbon (HC) contained in the exhaust gas in an exhaust line of an engine having a recirculation line having an HC adsorption/desorption device and through which the exhaust gas is recirculated to the engine and a warm-up catalytic converter (WCC), and comprising:
in response to detecting, by a controller, that the engine is turned on in a cold state, allowing the HC contained in the exhaust gas to be adsorbed to the HC adsorption/desorption device while recirculating the exhaust gas to the recirculation line;
firstly determining, by the controller, whether flow of the exhaust gas to the recirculation line is allowed by comparing a predetermined adsorption capacity of the HC adsorption/desorption device with an adsorption amount of HC adsorbed to the HC adsorption/desorption device;
as a result of comparing the predetermined adsorption capacity of the HC adsorption/desorption device with the adsorption amount of HC adsorbed to the HC adsorption/desorption device, when the adsorption amount is greater than the adsorption capacity, blocking, by the controller, flow of the exhaust gas to the recirculation line;
secondly determining, by the controller, whether flow of the exhaust gas to the recirculation line is allowed by detecting whether a three-way catalyst (TWC) of the WCC reaches a light-off temperature (LOT); and
when the TWC of the WCC reaches the LOT, allowing, by the controller, the HC adsorbed to the HC adsorption/desorption device to be desorbed due to a temperature of the exhaust gas by allowing flow of the exhaust gas to the recirculation line.

7. The control method of claim 6, wherein an HC adsorption catalyst that is provided in the HC adsorption/desorption device is zeolite, and in response to detecting that the engine is turned on, an EGR valve is opened to allow the exhaust gas to pass through the HC adsorption/desorption device to adsorb the HC contained in the exhaust gas to the HC adsorption/desorption device.

8. The control method of claim 7, wherein in the blocking flow of the exhaust gas to the recirculation line, the opened EGR valve is closed to block the exhaust gas from flowing to the recirculation line to stop adsorption of the HC contained in the exhaust gas to the HC adsorption/desorption device.

9. The control method of claim 8, wherein in the allowing the HC adsorbed to the HC adsorption/desorption device to be desorbed, the closed EGR valve is opened to allow flow of the exhaust gas to the recirculation line, wherein the HC adsorbed to the HC adsorption/desorption device is desorbed due to the temperature of the exhaust gas and flow into the engine, and then the HC that is discharged from the engine flows to the WCC for purification.

10. The control method of claim 6, wherein in the first determination of whether flow of the exhaust gas to the recirculation line is allowed, the predetermined adsorption capacity of the HC adsorption/desorption device is compared with the adsorption amount of HC adsorbed to the HC adsorption/desorption device and when the adsorption amount is equal to or less than the adsorption capacity, the EGR valve is maintained in an open state, and when the adsorption amount is greater than the adsorption capacity, the EGR valve is closed.

11. The control method of claim 6, wherein in the second determination of whether flow of the exhaust gas to the recirculation line is allowed, whether the TWC of the WCC reaches the LOT is detected and before the TWC of the WCC reaches the LOT, the EGR valve is maintained in a closed state, and after the TWC of the WCC reaches the LOT, the EGR valve is opened.
